(19) United States
(12) Patent Application Publication
(10) Pub. No.: US 2020/0264466 A1
(43) Pub. Date: Aug. 20, 2020

(54) DISPLAY DEVICE AND METHOD OF MANUFACTURING DISPLAY DEVICE

(71) Applicant: Sharp Kabushiki Kaisha, Sakai City (JP)

(72) Inventor: Masahiro YOSHIDA, Sakai City (JP)

(21) Appl. No.: 16/793,035

(22) Filed: Feb. 18, 2020

Related U.S. Application Data
(60) Provisional application No. 62/807,808, filed on Feb. 20, 2019.

(51) Int. Cl. G02F 1/1333; G06F 3/041; G02F 1/1362; G02F 1/1368

(52) U.S. Cl. CPC G02F 1/13338; G06F 3/0412; G02F 2201/121; G02F 1/1368; G02F 1/136286

(57) ABSTRACT

The technology includes: a substrate; a semiconductor layer on the substrate; gate electrodes; an electrode layer including source electrodes and drain electrodes to form thin film transistors in combination with the semiconductor layer and the gate electrodes; first touch panel lines extending in a first direction; second touch panel lines in the same layer as the first touch panel lines, the second touch panel lines extending in a second direction intersecting the first direction; and connecting sections in a layer other than the layer containing the first touch panel lines and the second touch panel lines, the connecting sections connecting either the first touch panel lines or the second touch panel lines in intersection regions.

### TECHNICAL FIELD

The disclosure relates to display devices and methods of manufacturing a display device.

### BACKGROUND ART

Patent Literature 1, as an example, discloses a touch-sensor-integrated display device including a thin film transistor array in which a touch sensor is integrated into a thin film transistor (may be referred to as a “TFT”). Patent Literature 1 further discloses a structure of such a touch-sensor-integrated display device where touch panel lines are drawn out in the X- and Y-directions, those routing wires which are arranged in the X-direction overlap gate lines, and those routing wires which are arranged in the Y-direction overlap data lines, in order to increase the precision of touch sensors and prevent aperture ratio decreases.

### CITATION LIST

### Patent Literature

Patent Literature 1: Japanese Unexamined Patent Application Publication, No. 2016-126778

### SUMMARY

### Technical Problem

The display device disclosed in Patent Literature 1 however requires a vertical stack of wires and therefore imposes strenuous conditions on manufacturing steps.

The disclosure, in an embodiment thereof, has an object to provide technology, for a touch-sensor-integrated display device, capable of reducing the number of manufacturing steps and lowering manufacturing cost while enhancing touch recognition precision and suppressing aperture ratio decreases.

### Solution to Problem

(1) The disclosure is directed to a display device including: a substrate; a semiconductor layer on the substrate; gate electrodes in either one or both of a layer on the semiconductor layer facing the substrate and a layer on the semiconductor layer opposite the substrate; an electrode layer including source electrodes and drain electrodes to form thin film transistors in combination with the semiconductor layer and the gate electrodes; first touch panel lines in a layer opposite the substrate with respect to the thin film transistors, the first touch panel lines extending in a first direction; second touch panel lines in the same layer as the first touch panel lines, the second touch panel lines extending in a second direction intersecting the first direction; and connecting sections in a layer other than the layer containing the first touch panel lines and the second touch panel lines, the connecting sections connecting either the first touch panel lines or the second touch panel lines in intersection regions including locations where the first touch panel lines would intersect the second touch panel lines.

(2) In the display device described in (1) above, the connecting sections are disposed in the same layer as the semiconductor layer.

(3) In the display device described in (2) above, the connecting sections include low-resistance semiconductor regions.

(4) The display device described in (1) above further includes common electrodes in a layer opposite the substrate with respect to the thin film transistors, wherein the connecting sections are disposed in the same layer as the common electrodes.

(5) In the display device described in (1) above, the connecting sections are disposed in the same layer as the gate electrodes.

(6) The display device described in (1) above further includes, in a layer on the semiconductor layer facing the substrate, a conductive light-blocking layer overlapping the semiconductor layer in a plan view, wherein the connecting sections are disposed in the same layer as the light-blocking layer.

(7) In the display device described in (1) above, the connecting sections are disposed in the same layer as the drain electrodes and the source electrodes.

(8) In the display device described in (1) above, either the first touch panel lines or the second touch panel lines include, in the intersection regions, first branch sections extending in a direction other than a direction in which either the first touch panel lines or the second touch panel lines that are connected to the connecting sections extend, and the connecting sections connect either the first touch panel lines or the second touch panel lines via the first branch sections.

(9) In the display device described in (1) above, the connecting sections include, in the intersection regions, second branch sections extending in a direction other than a direction in which either the first touch panel lines or the second touch panel lines that are connected to the connecting sections extend, and the connecting sections connect either the first touch panel lines or the second touch panel lines via the second branch sections.

(10) The display device described in (1) above further includes: gate lines connected to the gate electrodes and extending in the first direction; and source lines connected to the source electrodes and extending in the second direction, wherein the gate lines and the first touch panel lines at least partially overlap in a plan view, and the source lines and the second touch panel lines at least partially overlap in a plan view.

(11) The disclosure is directed also to a method of manufacturing a display device, the method including: forming thin film transistors on a substrate; forming first touch panel lines and second touch panel lines both in a single layer opposite the substrate with respect to the thin film transistors, the first touch panel lines extending in a first direction and the second touch panel lines extending in a second direction intersecting the first direction; and forming connecting sections in a layer other than the layer containing the first touch panel lines and the second touch panel lines, the connecting sections connecting either or both of the first touch panel lines and the second touch panel lines in intersection regions including locations where the first touch panel lines would intersect the second touch panel lines.

### Advantageous Effects of Disclosure

The disclosure, in an embodiment thereof, is capable of reducing the number of manufacturing steps and lowering manufacturing cost while enhancing touch recognition precision and suppressing aperture ratio decreases in touch-sensor-integrated display devices.

### BRIEF DESCRIPTION OF DRAWINGS

FIG. 1 is a schematic cross-sectional view of a structure of a display device in accordance with a first embodiment.

FIG. 2 is a schematic top view of wiring on an array substrate in accordance with the first embodiment.

FIG. 3 is a partial top view of a structure, near a pixel region, of the array substrate in accordance with the first embodiment.

FIG. 4 is a partial top view of a structure, near an intersection region, of the array substrate in accordance with the first embodiment.

FIG. 5 is a cross-sectional view of a structure of a TFT in accordance with the first embodiment.

FIG. 6 is a cross-sectional view of a structure of a first connecting section in accordance with the first embodiment.

FIG. 7 is a cross-sectional view of a structure of a second connecting section in accordance with the first embodiment.

FIG. 8 is a diagram representing a flow of manufacturing of the display device in accordance with the first embodiment.

FIG. 9 is a partial top view of a structure, near an intersection region, of an array substrate in accordance with a second embodiment.

FIG. 10 is a cross-sectional view of a structure of a TFT in accordance with the second embodiment.

FIG. 11 is a cross-sectional view of a structure of a third connecting section in accordance with the second embodiment.

### DESCRIPTION OF EMBODIMENTS

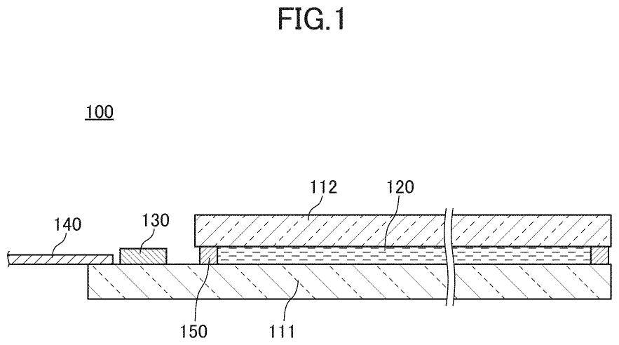

The following will describe illustrative embodiments of the disclosure with reference to drawings. Some of the drawings, showing an X-axis and a Y-axis, are drawn to match the directions indicated by these axes. FIG. 1 provides a reference for the vertical (up/down) directions: the top end of FIG. 1 indicates the upward direction whilst the bottom end of FIG. 1 indicates the downward direction. These definitions of directions are for convenience of description only and not intended to limit the orientation of the display device in accordance with the disclosure during the manufacture or use thereof. The same reference numerals in the drawings denote identical or equivalent members, and their description is omitted.

### First Embodiment

FIG. 1 is a schematic cross-sectional view of a structure of a display device 100 in accordance with the present embodiment. The display device 100 is, for example, a liquid crystal panel that has a touch panel function (position-dependent input function) as well as a display function. The display device 100 displays images using light projected by a backlight device (not shown). Referring to FIG. 1, the display device 100 includes a first substrate 111, a second substrate 112, a liquid crystal layer 120, a driver 130, a circuit board 140, and a sealing section 150.

The first substrate 111 is disposed above the backlight device (not shown). The first substrate 111 of the present embodiment is an array substrate 111 (wiring board, active matrix substrate) carrying TFTs and various wires (both described later in detail) formed on the top face thereof. The second substrate 112 of the present embodiment is disposed above the array substrate 111, so as to face the array substrate 111. The second substrate 112 is, for example, a CF substrate (opposite substrate) carrying color filters (not shown) and black matrices (not shown) formed on the top face thereof. The array substrate 111 and the CF substrate 112 are made of, for example, translucent glass. The array substrate 111 includes a first polarizer (not shown) on the bottom face thereof. The CF substrate 112 includes a second polarizer (not shown) on the top face thereof. The first and second polarizers are arranged in a crossed-Nicol position in which their polarization axes are orthogonal to each other.

The liquid crystal layer 120 is disposed between the array substrate 111 and the CF substrate 112. The liquid crystal layer 120 contains liquid crystal molecules that change their optical properties under an electric field. The sealing section 150 is disposed surrounding the liquid crystal layer 120 between the array substrate 111 and the CF substrate 112, to adhere the array substrate 111 and the CF substrate 112 together. The sealing section 150 is composed, for example, of photocuring resin such as ultraviolet curing resin.

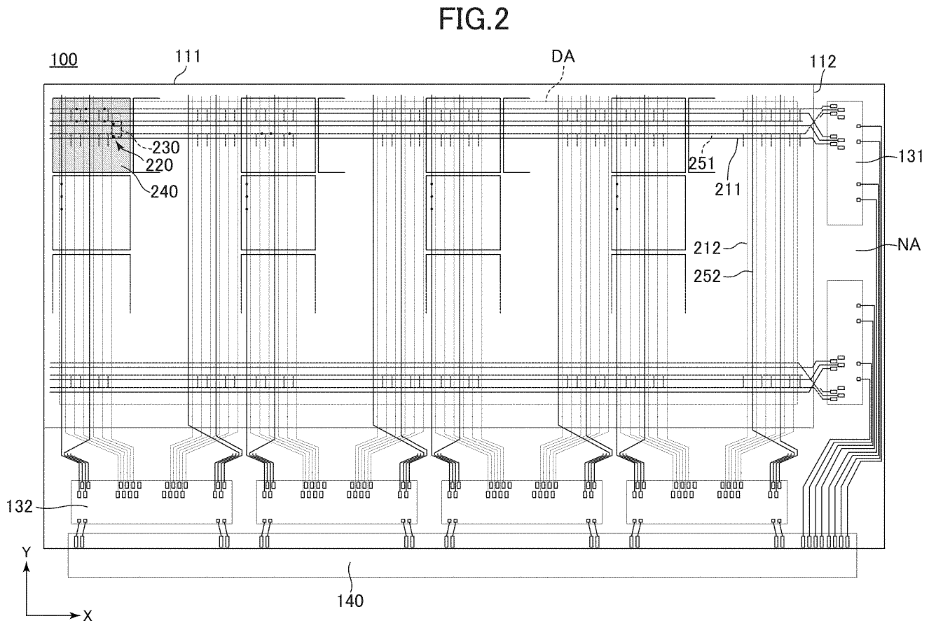

A description will be given next of a structure of the array substrate 111. FIG. 2 is a top view of the display device 100, schematically illustrating wiring on the array substrate 111 in accordance with the present embodiment.

Referring to FIG. 2, the array substrate 111 provides, at and around the center thereof, a display area DA where the display device 100 produces image displays. The array substrate 111 also provides, in a portion thereof that surrounds the display area DA, a non-display area (frame region NA) where the display device 100 does not produce image displays. The array substrate 111 of the present embodiment has larger dimensions than the CF substrate 112. The driver 130 (panel driving component) and the circuit board 140 (signal transfer member) are provided in a part of the frame region NA outside the CF substrate 112 in a plan view, to supply various signals related to the display and touch panel functions.

The driver 130 is built around, for example, an LSI chip that includes a driver circuit therein. The driver 130 is mounted to the frame region NA by, for example, COG (chip-on-glass) technology, to process the various signals fed from the circuit board 140. The driver 130 of the present embodiment includes first drivers 131 and second drivers 132. The first drivers 131 are disposed in an end portion of the frame region NA of the array substrate 111 with respect to a first direction (X-direction) and connected to the circuit board 140. The second drivers 132 are disposed in an end portion of the frame region NA of the array substrate 111 with respect to a second direction (Y-direction) and connected to the circuit board 140.

The circuit board 140 includes: a base member composed of, for example, an insulating and flexible synthetic resin material such as polyimide resin; and numerous wiring patterns (not shown) formed on the base member. As shown in FIG. 2, the circuit board 140 of the present embodiment has an end thereof connected to an end portion of the frame region NA of the array substrate 111 with respect to the Y-direction. The circuit board 140 has the other end thereof connected to a control board (not shown) serving as a signal source. The various signals supplied from the control board is transferred to the array substrate 111 via the circuit board 140 and processed by the driver 130 in the frame region NA for subsequent output to the display area DA.

The array substrate 111 of the present embodiment includes on the top face thereof a plurality of gate lines 211 (scan lines) and a plurality of source lines 212 (signal lines, data lines). The gate lines 211 extend in the first direction (X-direction) so as to traverse the display area DA. The source lines 212 extend in the second direction (Y-direction), which is a direction intersecting the gate lines 211, so as to traverse the display area DA. The gate lines 211 each have an end thereof connected to one of the first drivers 131, whereas the source lines 212 each have an end thereof connected to one of the second drivers 132.

Close to each intersection of the gate lines 211 and the source lines 212 are there provided a TFT 220 (switching element) and a pixel electrode 230 for applying a voltage across the liquid crystal layer 120. On the pixel electrode 230 is provided there a common electrode 240 having a plurality of slits (openings) formed therethrough. One of the gate lines 211 is connected to a gate electrode 520 of the TFT 220 (described later in detail) in the display area DA. One of the source lines 212 is connected to a source electrode 530 of the TFT 220 (described later in detail) in the display area DA. The common electrodes 240 of the present embodiment double-function as touch electrodes in a touch panel.

Each pixel electrode 230 is placed at an electrical potential that is in accordance with a data signal supplied via an associated one of the TFTs 220, to generate a fringe field causing rotation of the liquid crystal molecules between the pixel electrode 230 and the common electrode 240. The fringe field changes the retardation caused by the liquid crystal layer 120. This mechanism controls the liquid crystal layer 120 to transmit or block light. The display device 100 of the present embodiment works with, for example, liquid crystal of FFS (fringe field switching) mode as described here. The display device 100 may alternatively be a liquid crystal panel that works with a different type of liquid crystal such as liquid crystal of IPS (in-plane switching) mode.

The array substrate 111 of the present embodiment includes on the top face thereof a plurality of first touch panel lines 251 and a plurality of second touch panel lines 252. The first touch panel lines 251 and the second touch panel lines 252 feed signals related to the touch function to the common electrodes 240 and the driver 130. The first touch panel lines 251 extend in the first direction (X-direction) so as to traverse the display area DA. The second touch panel lines 252 extend in the second direction (Y-direction), which is a direction intersecting the first touch panel lines 251, so as to traverse the display area DA. The first touch panel lines 251 each have an end thereof connected to one of the first drivers 131 and connected in the display area DA to one of the common electrodes 240, whereas the second touch panel lines 252 each have an end thereof connected to one of the second drivers 132 and connected in the display area DA to one of the common electrodes 240. Drawing out the first touch panel lines 251 and the second touch panel lines 252 in different directions as described here enables every one of the common electrodes 240 to be connected to a touch panel line, which can enhance the touch recognition precision of the display device 100.

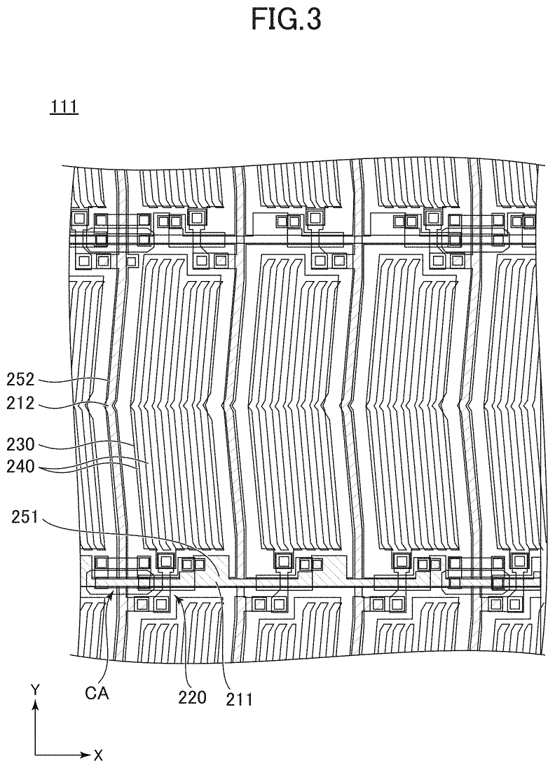

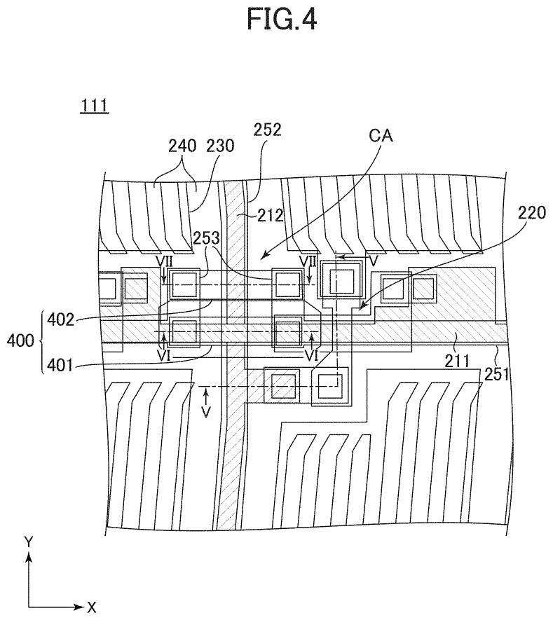

A description will be given next of a specific arrangement of the first touch panel lines 251 and the second touch panel lines 252. FIG. 3 is a partial top view of a structure, near a pixel region, of the array substrate 111 in accordance with the present embodiment. FIG. 4 is a partial top view of a structure, near an intersection region CA, of the array substrate 111 in accordance with the present embodiment.

Referring to FIGS. 3 and 4, the first touch panel lines 251 at least partially overlaps the gate line 211 in a plan view, whereas the-second touch panel lines 252 at least partially overlaps the source line 212 in a plan view. This arrangement can prevent the first touch panel lines 251 and the second touch panel lines 252 from blocking the light coming from the backlight, thereby restraining the aperture ratio of the display device 100 from decreasing.

The first touch panel lines 251 and the second touch panel lines 252 of the present embodiment are disposed in the same layer. Each first touch panel line 251 is connected by a connecting section 400 in the intersection region CA which contains a location where the first touch panel line 251 would intersect one of the second touch panel lines 252. Specifically, the first touch panel line 251 extends in the X-direction and terminates before intersecting the second touch panel line 252. Across the second touch panel line 252, the first touch panel line 251 extends again in the X-direction. These two parts of the discontinued first touch panel line 251, separated by the second touch panel line 252, are connected to each other by the connecting section 400 provided in a layer other than the layer containing the first touch panel lines 251 and the second touch panel lines 252. The intersection region CA refers to a region including: the site (point) where the first touch panel line 251, if continuing in the X-direction without terminating, would intersect the second touch panel line 252; and an area proximate to the site (point) where there is actually provided no first touch panel line 251.

The first touch panel lines 251 and the second touch panel lines 252, when arranged as described here, can be provided in the same layer and still insulated from each other. Therefore, the first touch panel lines 251 and the second touch panel lines 252 can be formed simultaneously. The arrangement therefore can reduce the number of manufacturing steps required in the manufacture of the display device 100, thereby lowering the manufacturing cost of the display device 100.

The display device 100 of the present embodiment, as described earlier, has a display function of displaying images and a touch panel function of detecting the locations of user inputs on the basis of the displayed images. The array substrate 111 further includes an integrated touch panel pattern to realize the touch panel function (in-cell technology). The touch panel pattern includes a plurality of common electrodes 240 (position detecting electrodes) provided in the display area DA on the top face of the array substrate 111. As the user moves a position input body (e.g., his/her finger) close to the display area DA of the display device 100, the position input body and at least one of the common electrodes 240 form an electrostatic capacitance therebetween. The display device 100 then detects, based on the electrostatic capacitance, the positions of inputs made by the user using the position input body.

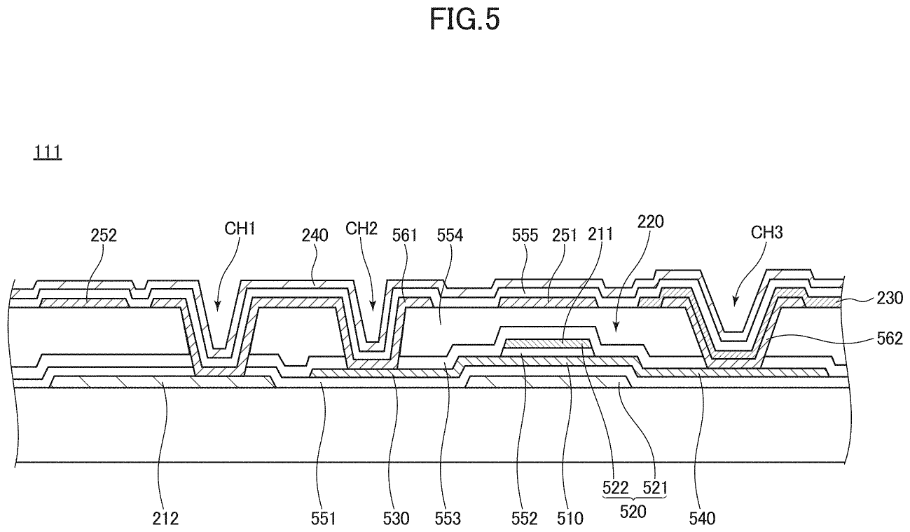

A description will be given next of a structure in and around the TFT 220 of the present embodiment. FIG. 5 is a cross-sectional view of the structure taken along line V-V shown in FIG. 4.

The array substrate 111 of the present embodiment includes: a semiconductor layer 510 on the array substrate 111; the gate electrodes 520 in either a layer on the semiconductor layer 510 facing the array substrate 111 or a layer on the semiconductor layer 510 opposite the array substrate 111 or in both layers; and an electrode layer containing the source electrodes 530 and drain electrodes 540 forming the TFTs 220 when combined with the semiconductor layer 510 and the gate electrodes 520. The array substrate 111 includes: the first touch panel lines 251 in a layer opposite the array substrate 111 with respect to the TFT 220; and the second touch panel lines 252 in the same layer as the first touch panel lines 251.

Specifically, as shown in FIG. 5, the array substrate 111 of the present embodiment includes first gate electrodes 521, a first insulating layer 551, the semiconductor layer 510, a second insulating layer 552, second gate electrodes 522, a third insulating layer 553, and a fourth insulating layer 554, all stacked on the top face of the array substrate 111 in this sequence when viewed from the array substrate 111. Each TFT 220 of the present embodiment is formed by the semiconductor layer 510 and an electrode layer that in turn includes one of the first gate electrodes 521, one of the second gate electrodes 522, one of the source electrodes 530 connected to the semiconductor layer 510, and one of the drain electrodes 540 connected to the semiconductor layer 510.

In other words, the TFT 220 of the present embodiment is a double-gate TFT including: one of the first gate electrodes 521 in a layer located on the array substrate 111 side of the semiconductor layer 510 (i.e., in a layer below the semiconductor layer 510); and one of the second gate electrodes 522 in a layer located on the opposite side of the semiconductor layer 510 to the array substrate 111 (i.e., in a layer above the semiconductor layer 510). The first gate electrodes 521 of the present embodiment serve as a light-blocking layer shielding the semiconductor layer 510 from the light coming from the backlight. A light-blocking layer other than the first gate electrodes 521 may be provided below the first gate electrodes 521. The pattern formed by the first gate electrodes 521 in the present embodiment may not be necessarily connected to the gate lines 211 and the second gate electrodes 522. Accordingly, the TFT 220 may be a top-gate TFT in which the second gate electrode 522 alone serves as a gate electrode, in which case the pattern formed by the first gate electrodes 521 in the present embodiment serves as a light-blocking layer. As another alternative, the TFT 220 may be a bottom-gate TFT.

The semiconductor layer 510 is disposed on the first insulating layer 551 so as to vertically overlap the first gate electrodes 521 in a plan view. The second gate electrodes 522 are disposed on the second insulating layer 552 so as to vertically overlap the semiconductor layer 510 in a plan view. The first insulating layer 551 and the second insulating layer 552 hence serve as gate insulating layers. The second gate electrodes 522 are formed by parts of the gate lines 211. The gate lines 211 and the second gate electrodes 522 are mutually connected.

In the TFT 220 of the present embodiment, the semiconductor layer 510, the source electrodes 530, and the drain electrode 540 are integrally formed of the same semiconductor material. The source electrodes 530 and the drain electrodes 540 (at least the top faces thereof) are subjected to a resistance-reducing process. This process renders the source electrodes 530 and the drain electrodes 540 more electrically conductive than the semiconductor layer 510 serving as channel sections of the TFTs 220. The semiconductor material processed for increased conductance as described here will be referred to as a low-resistance semiconductor, and the parts of an integrally fabricated semiconductor material that have a low resistance will be referred to as low-resistance semiconductor regions. The source electrodes 530 and the drain electrodes 540 may be provided separately from the semiconductor layer 510. In other words, the source electrodes 530 and the drain electrodes 540 may be formed of a metal or like conductive material separately from the semiconductor layer 510.

The array substrate 111 of the present embodiment includes the source lines 212 disposed in the same layer as the first gate electrodes 521. The source lines 212 are connected to the source electrodes 530 via a first wiring layer 561. The first wiring layer 561 is connected to the source lines 212 inside contact holes CH1 formed through the first insulating layer 551, the third insulating layer 553, and the fourth insulating layer 554 on the source lines 212 and also connected to the source electrodes 530 inside contact holes CH2 formed through the third insulating layer 553 and the fourth insulating layer 554 on the source electrodes 530.

On the drain electrodes 540 of the present embodiment are there provided a second wiring layer 562 and the pixel electrodes 230. The drain electrodes 540 are connected to the pixel electrodes 230 via the second wiring layer 562. The second wiring layer 562 is connected to the drain electrodes 540 inside contact holes CH3 formed through the third insulating layer 553 and the fourth insulating layer 554 on the drain electrodes 540. The pixel electrodes 230 are provided on the second wiring layer 562 so as to cover the second wiring layer 562. The pixel electrodes 230 may be connected directly to the drain electrodes 540 with no second wiring layer 562 intervening therebetween.

The first touch panel lines 251 and the second touch panel lines 252 of the present embodiment are at least partially disposed in the same layer. In other words, the first touch panel lines 251 and the second touch panel lines 252 are at least partially disposed on the fourth insulating layer 554. The first touch panel lines 251 at least partially vertically overlap the gate lines 211 in a plan view. The second touch panel lines 252 at least partially vertically overlap the source lines 212 in a plan view.

The array substrate 111 of the present embodiment further includes the common electrodes 240 in a layer opposite the substrate with respect to the TFTs 220. Specifically, as shown in FIG. 5, a fifth insulating layer 555 is disposed above the first touch panel lines 251, the second touch panel lines 252, the first wiring layer 561, and the second wiring layer 562. The common electrodes 240 are disposed above the fifth insulating layer 555. This structure insulates the common electrodes 240 from the first touch panel lines 251, the second touch panel lines 252, the first wiring layer 561, and the second wiring layer 562.

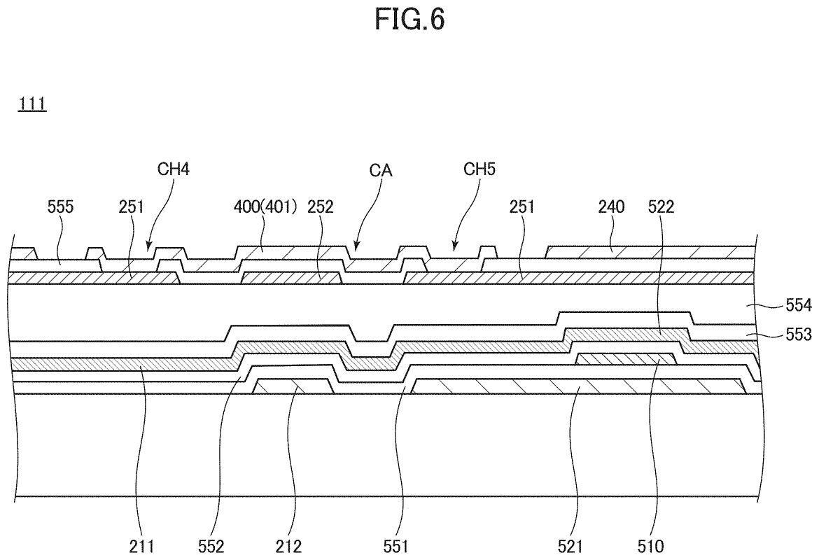

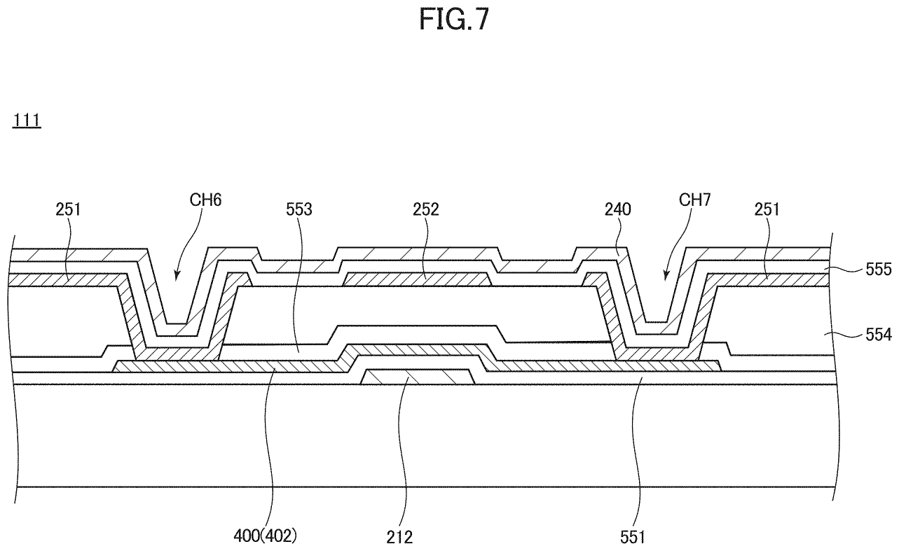

A description will be given next of a structure of the connecting sections 400. FIG. 6 is a cross-sectional view of the structure taken along line VI-VI shown in FIG. 4. FIG. 7 is a cross-sectional view of the structure taken along line VII-VII shown in FIG. 4.

Referring to FIGS. 6 and 7, the connecting sections 400 of the present embodiment are provided in a layer other than the layer containing the first touch panel lines 251 and the second touch panel lines 252. The connecting sections 400 connect the first touch panel lines 251 in the intersection regions CA. Each connecting section 400 includes a first connecting section 401 and a second connecting section 402.

Specifically, as shown in FIG. 6, the first connecting section 401 of the present embodiment is at least partially disposed in the same layer as the common electrodes 240. In other words, the first connecting section 401 is at least partially disposed on the fifth insulating layer 555. The first connecting section 401 connects the two parts of the first touch panel line 251 discontinued in the intersection region CA to each other inside contact holes CH4 and CH5 formed through the fifth insulating layer 555.

The first connecting section 401 is formed simultaneously with the common electrodes 240. The first connecting section 401 can therefore be formed with no additional manufacturing steps. As described earlier, the first connecting section 401 is provided in a layer other than the layer containing the first touch panel lines 251 and the second touch panel lines 252. Therefore, the first touch panel lines 251 and the second touch panel lines 252 are insulated from each other even if the first touch panel lines 251 and the second touch panel lines 252 are disposed in the same layer.

The first touch panel lines 251 of the present embodiment is connected also by the second connecting section 402 in the intersection region CA as shown in FIGS. 4 and 7. Specifically, each first touch panel line 251 of the present embodiment includes, in the intersection region CA, a first branch section 253 extending in a direction other than the direction in which the first touch panel line 251 extends. The second connecting section 402 connects the discontinued first touch panel line 251 via these first branch sections 253.

More specifically, as shown in FIG. 4, the first touch panel line 251 of the present embodiment includes a pair of first branch sections 253 extending in the second direction (Y-direction) in the intersection region CA where the first touch panel lines 251 would intersect the second touch panel line 252. The second connecting section 402, as shown in FIG. 7, is disposed in the same layer as the source electrode 530 and the drain electrode 540. Specifically, the second connecting section 402 is disposed in the same layer as the source electrode 530 and the drain electrode 540 and in such a manner that the second connecting section 402 does not overlap the gate line 211 including the second gate electrode 522. The pair of first branch sections 253 is connected to the second connecting section 402 inside contact holes CH6 and CH7 formed through the third insulating layer 553 and the fourth insulating layer 554 on the second connecting section 402. This arrangement connects together the two parts of the first touch panel line 251 discontinued in the intersection region CA. The source electrodes 530, the drain electrodes 540, and the second connecting sections 402 are formed simultaneously. The second connecting sections 402 can therefore be formed with no additional manufacturing steps.

As described here, the first touch panel lines 251 of the present embodiment are connected in the intersection region CA by the two connecting sections 400 (i.e., the first connecting section 401 and the second connecting section 402). This structure enables the connecting section 400 to more reliably connect the two parts of the first touch panel line 251 discontinued in the intersection region CA. In addition, the structure can suppress decreases in touch recognition precision because the electric resistance of the connecting section 400 can be reduced even if the first touch panel lines 251 are connected by the connecting section 400 in the intersection region CA.

The connecting section 400 may alternatively connect the second touch panel lines 252 in the intersection region CA. In other words, the second touch panel lines 252 may terminate in the intersection region CA where the second touch panel lines 252 would intersect the first touch panel lines 251. The connecting section 400 may connect two parts of the second touch panel line 252 discontinued in the intersection region CA to each other. As another alternative, the connecting section 400 may include either one of the two connecting sections 400 (i.e., either one of the first connecting section 401 and the second connecting section 402). For instance, in vary small pixels, it may be difficult to provide the first connecting section 401 and at the same time secure a sufficient area in the common electrodes 240 for the provision of slits (openings) for generating a fringe field. If the second connecting section 402 is formed by subjecting a semiconductor film to a resistance-reducing process using the second insulating layer 552 and the gate lines 211 including the second gate electrodes 522 as a mask as will be detailed later, the pattern of the second connecting section 402, formed so as to overlap the gate lines 211, has a resistance that cannot be reduced, and the connecting section 400 consequently has an increased resistance. In these cases, either one of the first connecting section 401 and the second connecting section 402 may entirely constitute the connecting section 400. If the connecting section 400 includes only either one of the connecting sections 400 (i.e., either one of the first connecting section 401 and the second connecting section 402), the connecting section 400 may have its width increased to reduce resistance thereof. For instance, if the connecting section 400 includes only the first connecting section 401, the first connecting section 401 may have its width so increased that the first connecting section 401 would reach the region where the second connecting section 402 was formed (see FIG. 3).

The semiconductor layer 510, the source electrodes 530, and the drain electrodes 540 are integrally formed in the present embodiment as described earlier. The second connecting sections 402 are therefore disposed in the same layer as the semiconductor layer 510. Also as described earlier, the source electrodes 530 and the drain electrodes 540 of the present embodiment are formed of a low-resistance semiconductor. The second connecting section 402 therefore includes a low-resistance semiconductor region. Specifically, the second connecting section 402, so disposed as not to overlap the gate lines 211 including the second gate electrodes 522, has at least a low-resistance semiconductor region.

The connecting sections 400 may be disposed in the same layer as the gate electrodes 520. The connecting sections 400 may alternatively be disposed in the same layer as the light-blocking layer. These structures also enable the connecting section 400 to connect the first touch panel lines 251 or the second touch panel lines 252 in the intersection region CA. The structures enable the formation of the connecting sections 400 with no additional manufacturing steps.

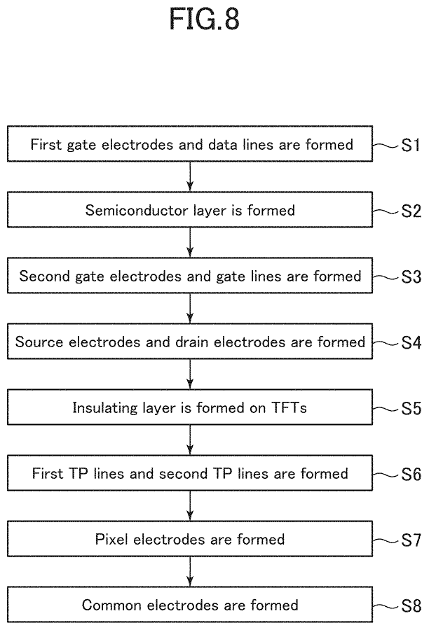

A description will be given next of a method of manufacturing the display device 100 in accordance with the present embodiment. FIG. 8 is a diagram representing a flow of manufacturing of the display device 100 in accordance with the present embodiment.

A method of manufacturing a display device 100 in accordance with the present embodiment involves: forming TFTs 220 on a substrate; forming first touch panel lines 251 and second touch panel lines 252 both in a single layer on the TFTs 220 opposite the substrate such that the first touch panel lines 251 extend in a first direction and the second touch panel lines 252 extend in a second direction intersecting the first direction; and forming connecting sections 400 in a layer other than the layer containing the first touch panel lines 251 and the second touch panel lines 252, the connecting sections 400 connecting either or both of the first touch panel lines 251 and the second touch panel lines 252 in intersection regions CA including locations where the first touch panel lines 251 would intersect the second touch panel lines 252.

Specifically, a first conductive film is first formed on the first substrate (array substrate) 111 by, for example, sputtering and subjected to photolithography using a photomask to form a photoresist pattern. The first conductive film is then etched into a pattern using the photoresist pattern as a mask. The photoresist pattern is then removed, leaving the first gate electrodes 521 (light-blocking layer) and the source lines 212 (step S1).

Next, the first insulating layer 551 is formed on the first gate electrodes 521 (light-blocking layer) and the source lines 212 by, for example, CVD (chemical vapor deposition). A semiconductor film is then formed by sputtering and subsequently subjected to photolithography using a photomask to form a photoresist pattern. The semiconductor film is then etched into a pattern using the photoresist pattern as a mask. The photoresist pattern is removed, leaving the semiconductor layer 510 (step S2). The semiconductor layer 510 of the present embodiment is formed of, for example, an oxide semiconductor such as InGaZnO.

Next, the second insulating layer 552 is formed on the semiconductor layer 510 by CVD. A second conductive film is then formed by sputtering and subjected to photolithography using a photomask to form a photoresist pattern. The second conductive film is then etched into a pattern using the photoresist pattern as a mask to form the gate lines 211 including the second gate electrodes 522 (step S3). The second insulating layer 552 is subsequently etched into a pattern using the same photoresist pattern. Thereafter, the photoresist pattern is removed.

Next, a semiconductor film formed integrally with the semiconductor layer 510 is subjected to a resistance-reducing process using the second insulating layer 552 and the gate lines 211 including the second gate electrodes 522 as a mask, to form the drain electrodes 540, the source electrodes 530, and the second connecting sections 402 (step S4). A resistance-reducing process, for example, reduces oxygen in the surface of the semiconductor layer 510 by plasma processing in a hydrogen atmosphere, thereby lowering the resistivity of the surface, to improve conductance. These manufacturing steps form, on the array substrate 111, the TFTs 220 including the semiconductor layer 510, the gate electrodes 520, the source electrodes 530, and the drain electrodes 540.

The semiconductor layer 510 may be formed of a different semiconductor material such as polysilicon. If the semiconductor layer 510 is formed of polysilicon, the drain electrodes 540, the source electrodes 530, and the second connecting sections 402 are formed by doping the polysilicon with, for example, an impurity such as phosphorus or boron to reduce the resistance of the polysilicon.

Next, the third insulating layer 553 is formed on the second gate electrodes 522 and the gate lines 211 by CVD. A photosensitive organic film material is then applied onto the third insulating layer 553 by, for example, spin- or slit-coating and patterned by photolithography using a photomask to form the fourth insulating layer 554. This manufacturing step forms an insulating layer on the TFTs 220 (step S5). The third insulating layer 553 is then etched using the pattern of the fourth insulating layer 554 to form contact holes through the third insulating layer 553. Thereafter, the first insulating layer 551 and the third insulating layer 553 are etched using the same pattern of the fourth insulating layer 554, to form the contact holes CH1, CH2, CH3, CH6, and CH7.

Next, a third conductive film is formed on the fourth insulating layer 554 by sputtering and subjected to photolithography using a photomask to form a photoresist pattern. The third conductive film is then etched into a pattern using the photoresist pattern as a mask. The photoresist pattern is removed, simultaneously forming the second touch panel lines 252, the first wiring layer 561, the second wiring layer 562, and the first touch panel lines 251 including the first branch sections 253 (step S6). The first touch panel lines 251 are formed so as to terminate in the intersection regions CA including locations where the first touch panel lines 251 would intersect the second touch panel lines 252. The first touch panel lines 251 are however connected to the second connecting sections 402 inside the contact holes CH6 and CH7. Therefore, the two parts of the first touch panel line 251 discontinued in the intersection region CA are connected to each other by the second connecting section 402.

The source lines 212, the gate lines 211, the first touch panel lines 251, the second touch panel lines 252, the first wiring layer 561, and the second wiring layer 562 may be formed of, for example, a metal such as copper, titanium, aluminum, molybdenum, or tungsten or an alloy of these metals.

Subsequently, a first transparent conductive film is formed on the second wiring layer 562 by sputtering and subjected to photolithography using a photomask to form a photoresist pattern. The first transparent conductive film is then etched into a pattern using the photoresist pattern as a mask. The photoresist pattern is removed, leaving the pixel electrodes 230 (step S7). The fifth insulating layer 555 is then formed on the first touch panel lines 251, the second touch panel lines 252, the first wiring layer 561, and the pixel electrodes 230 by CVD.

Thereafter, the contact holes CH4 and CH5 are formed through the fifth insulating layer 555. A second transparent conductive film is formed by sputtering and subjected to photolithography using a photomask to form a photoresist pattern. The second transparent conductive film is then etched into a pattern using the photoresist pattern as a mask. The photoresist pattern is removed, simultaneously forming the first connecting sections 401 and the common electrodes 240. The two parts of the first touch panel line 251 discontinued in the intersection region CA are consequently connected to each other by the first connecting section 401 inside the contact holes CH4 and CH5.

The first to fifth insulating layers 551, 552, 553, 554, and 555 may be formed of, for example, a film of an inorganic material such as silicon nitride (SiN_{X}) or silicon oxide (SiO₂) or a stack of such films. The first connecting sections 401, the pixel electrodes 230, and the common electrodes 240 may be formed of, for example, a transparent conductive material such as indium tin oxide (ITO), indium zinc oxide (IZO), zinc oxide (ZnO), or tin oxide (SnO) or an alloy of these metals.

In the display device 100 of the present embodiment, the first touch panel lines 251 and the second touch panel lines 252, arranged as described here, can be simultaneously formed without being connected to each other. The two parts of the first touch panel line 251 discontinued in the intersection region CA are connected to each other by the first connecting section 401 and the second connecting section 402 provided in a layer other than the layer containing the first touch panel lines 251 and the second touch panel lines 252. The first connecting sections 401 are formed simultaneously with common electrodes. The second connecting sections 402 are formed simultaneously with the source electrodes 530 and the drain electrodes 540. The connecting sections 400 can therefore be formed with no additional manufacturing steps. Hence, the number of manufacturing steps required for the manufacture of the display device 100 can be reduced, which in turn lowers the manufacturing cost of the display device 100.

### Second Embodiment

Next, a second embodiment will be described. The following description will focus on differences from the first embodiment and may not mention features that are common to both the first and second embodiments. The second embodiment differs from the first embodiment in the structure of the TFTs 220 and the connecting sections 400.

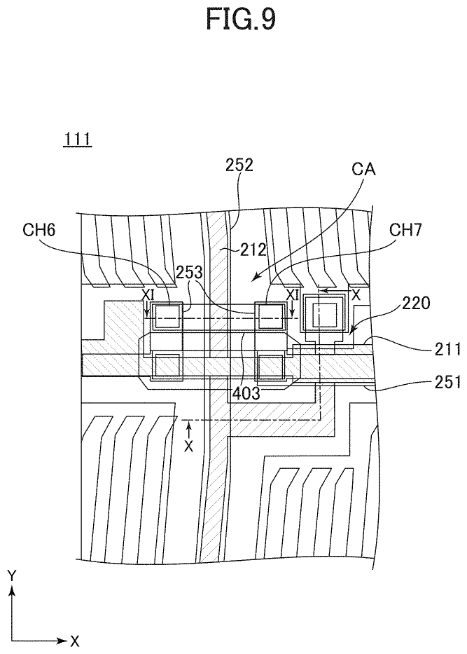

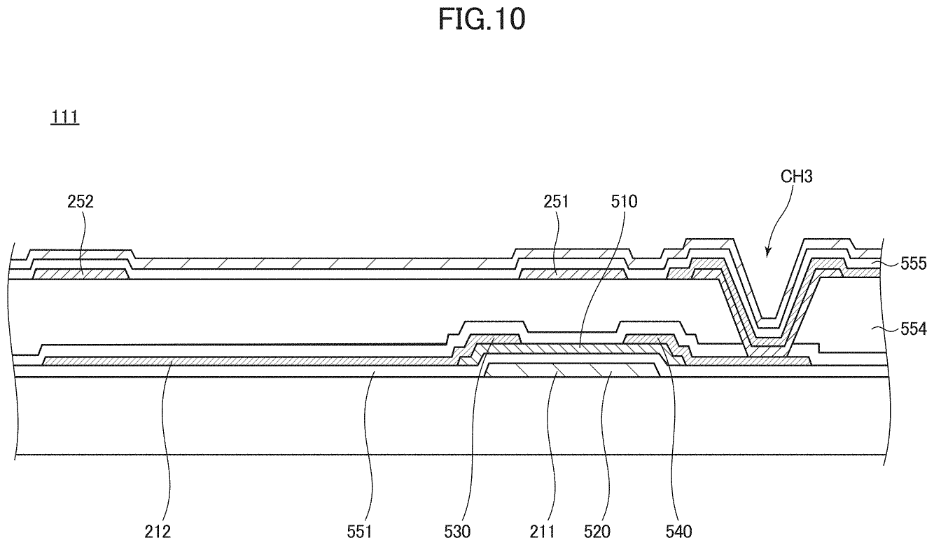

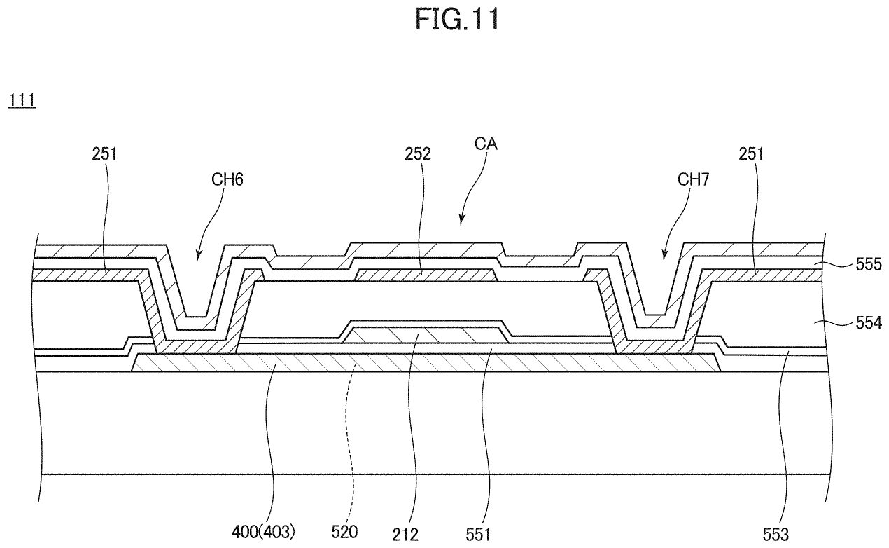

FIG. 9 is a partial top view of a structure, near an intersection region CA, of an array substrate 111 in accordance with the second embodiment. FIG. 10 is a cross-sectional view, taken along line X-X shown in FIG. 9, of a structure of the TFTs 220 in accordance with the second embodiment. FIG. 11 is a cross-sectional view taken along line XI-XI shown in FIG. 9.

Referring to FIG. 10, the array substrate 111 of the present embodiment includes gate electrodes 520, a first insulating layer 551, and a semiconductor layer 510, all stacked on the top face of the array substrate 111 in this sequence when viewed from the array substrate 111. The semiconductor layer 510 is connected to source electrodes 530 and drain electrodes 540. The gate electrodes 520 are connected to gate lines 211 disposed in the same layer as the gate electrodes 520. The TFTs 220 of the present embodiment are, as described here, bottom-gate TFTs including the gate electrodes 520 in a layer located on the array substrate 111 side of the semiconductor layer 510 (i.e., in a layer below the semiconductor layer 510).

As shown in FIG. 9, each first touch panel line 251 is disposed so as to at least partially overlap one of the gate lines 211 in a plan view, whereas each second touch panel line 252 is disposed so as to at least partially overlap one of the source lines 212 in a plan view. The first touch panel line 251 terminates before intersecting the second touch panel line 252. Across the second touch panel line 252, the first touch panel line 251 extends again in the X-direction. These two parts of the discontinued first touch panel line 251, separated by the second touch panel line 252, are connected to each other by a first connecting section 401 and a third connecting section 403 provided in a layer other than the layer containing the first touch panel lines 251 and the second touch panel lines 252. The first connecting section 401 has the same structure as in the first embodiment, and its description is omitted.

Referring to FIG. 9, the first touch panel line 251 of the present embodiment includes a pair of first branch sections 253 extending in the Y-direction. The third connecting section 403 is disposed in the same layer as the gate electrode 520 (gate line) as shown in FIG. 11. The pair of first branch sections 253 is connected to the third connecting section 403 inside contact holes CH6 and CH7 formed through the first insulating layer 551, the third insulating layer 553, and the fourth insulating layer 554 on the third connecting section 403. This arrangement connects together the two parts of the first touch panel line 251 discontinued in the intersection region CA.

The first touch panel lines 251 and the second touch panel lines 252, arranged as described here, can be provided in the same layer without being connected to each other even in a structure where the connecting sections 400 are provided in the same layer as the gate electrodes 520 (gate lines). The first touch panel lines 251 and the second touch panel lines 252 can therefore be simultaneously formed. In addition, the third connecting sections 403 can be formed simultaneously with the gate electrodes 520. Hence, the number of manufacturing steps required for the manufacture of the display device 100 can be reduced, which in turn lowers the manufacturing cost.

### Variation Examples

Main embodiments of the disclosure have been described so far. The disclosure is however not limited to these embodiments.

The first touch panel lines 251 are described in the foregoing embodiments as including the first branch sections 253. The connecting sections 400 connect the first touch panel lines 251 in the intersection regions CA via the first branch sections 253. Alternatively, the first touch panel lines 251 may include no first branch sections 253, so that the first connecting sections 401 instead include second branch sections. Specifically, each first connecting section 401 may include on each X-direction end thereof a second branch section extending in the Y-direction, in which case the two parts of the first touch panel line 251 discontinued in the intersection region CA are connected together via the second branch section of the first connecting section 401.

The first connecting sections 401, each constituting a part of the connecting section 400, are described in the foregoing first embodiment as being disposed in the same layer as the common electrodes. The second connecting sections 402, each constituting a part of the connecting section 400, are described in the first embodiment as being disposed in the same layer as the source electrodes 530 and the drain electrodes 540. The third connecting sections 403, each constituting a part of the connecting section 400, are described in the foregoing second embodiment as being disposed in the same layer as the gate electrodes 520 (gate lines). The connecting sections 400 of the disclosure do not necessarily have such a structure. The connecting sections 400 may be disposed, for example, in the same layer as the source lines (signal lines, data lines).

The TFT 220 is described as being a double-gate TFT in the foregoing first embodiment and as being a bottom-gate TFT in the foregoing second embodiment. As a further alternative, the TFT 220 of the disclosure may be a top-gate TFT. In such cases, the TFT 220 may include a light-blocking layer shielding the semiconductor layer 510 from the light coming from the backlight, and the connecting sections 400 may be disposed in the same layer as the light-blocking layer.

The elements and devices described in the embodiments and variation examples above may be combined in a suitable manner.

1. A display device comprising:
a substrate;
a semiconductor layer on the substrate;
gate electrodes in either one or both of a layer on the semiconductor layer facing the substrate and a layer on the semiconductor layer opposite the substrate;
an electrode layer including source electrodes and drain electrodes to form thin film transistors in combination with the semiconductor layer and the gate electrodes;
first touch panel lines in a layer opposite the substrate with respect to the thin film transistors, the first touch panel lines extending in a first direction;
second touch panel lines in the same layer as the first touch panel lines, the second touch panel lines extending in a second direction intersecting the first direction; and
connecting sections in a layer other than the layer containing the first touch panel lines and the second touch panel lines, the connecting sections connecting either the first touch panel lines or the second touch panel lines in intersection regions including locations where the first touch panel lines would intersect the second touch panel lines.

2. The display device according to claim 1, wherein the connecting sections are disposed in a layer containing the semiconductor layer.

3. The display device according to claim 2, wherein the connecting sections include low-resistance semiconductor regions.

4. The display device according to claim 1, further comprising common electrodes in a layer opposite the substrate with respect to the thin film transistors, wherein the connecting sections are disposed in the same layer as the common electrodes.

5. The display device according to claim 1, wherein the connecting sections are disposed in the same layer as the gate electrodes.

6. The display device according to claim 1, further comprising, in a layer on the semiconductor layer facing the substrate, a conductive light-blocking layer overlapping the semiconductor layer in a plan view, wherein the connecting sections are disposed in the same layer as the light-blocking layer.

7. The display device according to claim 1, wherein the connecting sections are disposed in the same layer as the drain electrodes and the source electrodes.

8. The display device according to claim 1, wherein:
either the first touch panel lines or the second touch panel lines include, in the intersection regions, first branch sections extending in a direction other than a direction in which either the first touch panel lines or the second touch panel lines that are connected to the connecting sections extend; and
the connecting sections connect either the first touch panel lines or the second touch panel lines via the first branch sections.

9. The display device according to claim 1, wherein:
the connecting sections include, in the intersection regions, second branch sections extending in a direction other than a direction in which either the first touch panel lines or the second touch panel lines that are connected to the connecting sections extend; and
the connecting sections connect either the first touch panel lines or the second touch panel lines via the second branch sections.

10. The display device according to claim 1, further comprising:
gate lines connected to the gate electrodes and extending in the first direction; and
source lines connected to the source electrodes and extending in the second direction, wherein
the gate lines and the first touch panel lines at least partially overlap in a plan view, and
the source lines and the second touch panel lines at least partially overlap in a plan view.

11. A method of manufacturing a display device, the method comprising:
forming thin film transistors on a substrate;
forming first touch panel lines and second touch panel lines both in a single layer opposite the substrate with respect to the thin film transistors, the first touch panel lines extending in a first direction and the second touch panel lines extending in a second direction intersecting the first direction; and
forming connecting sections in a layer other than the layer containing the first touch panel lines and the second touch panel lines, the connecting sections connecting either or both of the first touch panel lines and the second touch panel lines in intersection regions including locations where the first touch panel lines would intersect the second touch panel lines.
